(19) United States
(12) Patent Application Publication
(10) Pub. No.: US 2005/0110990 A1
(43) Pub. Date: May 26, 2005

(54) Method and device for detecting small numbers of molecules using surface-enhanced coherent anti-Stokes Raman spectroscopy

(76) Inventors: Tae-Woong Koo, Cupertino, CA (US); Christopher M. Gerth, Newport Beach, CA (US); Mineo Yamakawa, Campbell, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/966,893

(22) Filed: Oct. 15, 2004

Related U.S. Application Data
(63) Continuation-in-part of application No. 10/688,680, filed on Oct. 17, 2003.

(51) Int. Cl. G01J 3/44

(52) U.S. Cl. 356/301

(57) ABSTRACT

The device and method disclosed herein concern detecting, identifying, and or quantifying analytes, such as nucleic acids, with high resolution and fast response times using surface enhanced coherent anti-Stokes Raman spectroscopy. In certain embodiments of the invention, a small number molecular sample of the analyte 210 such as a nucleotide, passes through a microfluidic channel, microchannel, or nanochannel 185 and sample cell 175 that contains Raman-active surfaces, and is detected by surface enhanced, coherent anti-Stokes Raman spectroscopy (SECARS). Other embodiments of the invention concern an apparatus for analyte detection.

### CROSS REFERENCE TO RELATED APPLICATIONS

The present application is a continuation-in-part of U.S. application Ser. No. 10/688,680, filed Oct. 17, 2003, the disclosure of which is incorporated herein by reference.

### FIELD OF THE INVENTION

Embodiments of the invention relate to the field of molecular analysis by spectroscopy. More particularly, the invention relates generally to methods and devices for use in biological, biochemical, and chemical testing, and particularly to methods, instruments, and the use of instruments which utilize surface enhanced coherent anti-Stokes Raman spectroscopy (SECARS) for detecting, identifying, or sequencing molecules, such as nucleic acids.

### BACKGROUND OF THE INVENTION

The sensitive and accurate detection and/or identification of small numbers of molecules from biological and other samples has proven to be an elusive goal, with widespread potential uses in medical diagnostics, pathology, toxicology, environmental sampling, chemical analysis, forensics and numerous other fields. Attempts have been made to use Raman spectroscopy and/or surface plasmon resonance to achieve this goal. When light passes through a medium of interest, a certain amount becomes diverted from its original direction. This phenomenon is known as scattering. Some of the scattered light differs in frequency from the original excitatory light, due to a) the absorption of light by the medium, b) excitation of electrons in the medium to a higher energy state, and c) subsequent emission of the light from the medium at a different wavelength. When the frequency difference matches the energy level of the molecular vibrations of the medium of interest, this process is known as Raman scattering. The wavelengths of the Raman emission spectrum are characteristic of the chemical composition and structure of the molecules absorbing the light in a sample, while the intensity of light scattering is dependent on the concentration of molecules in the sample as well as the structure of the molecule. When the wavelength of the emitted light in Raman scattering is longer than the wavelength of the excitatory light, this is known as Stokes Raman scattering. When the wavelength of the emitted light is shorter that the wavelength of the excitatory light, this is known as anti-Stokes Raman scattering.

The probability of Raman interaction occurring between an excitatory light beam and an individual molecule in a sample is very low, resulting in a low sensitivity and limited applicability of Raman analysis. The “optical cross section” is a term that indicates the probability of an optical event occurring which is induced by a particular molecule or a particle. When photons impinge on a molecule, only some of the photons that geometrically impinge on the molecule interact with the molecule optically. The cross section is the multiple of the geometric cross-section and the probability of the optical event. Optical cross-sections include absorption cross-section (for photon absorption process), Rayleigh scattering cross-section or scattering cross-section (for Rayleigh scattering), and Raman scattering cross-section (for Raman scattering).

For the optical detection and spectroscopy of small numbers of molecules, cross sections of >10⁻¹⁶ cm²/molecule or more are desired and cross-sections of >10⁻²¹ cm²/molecule or more are necessary. Typical spontaneous Raman scattering techniques have cross sections of about 10⁻³⁰ cm²/molecule, and thus are not suitable for single molecule detection.

It has been observed that molecules near roughened silver surfaces show enhanced Raman scattering of as much as six to seven orders of magnitude. This surface enhanced Raman spectroscopic (SERS) effect is related to the phenomenon of plasmon resonance, wherein a metal surface exhibits a pronounced optical resonance in response to incident electromagnetic radiation, due to the collective coupling of conduction electrons in the metal. In essence, metal surface can function as miniature “antenna” to enhance the localized effects of electromagnetic radiation. Molecules located in the vicinity of such surfaces exhibit a much greater sensitivity for Raman spectroscopic analysis.

SERS is usually accomplished by using either rough metal films which are attached to a substrate as part of the sample cell of the spectroscopic measuring device or by introducing metallic nanoparticles or colloids as part of a suspension into the sample cell. The sample is then applied to these metal surfaces. SERS techniques can give strong intensity enhancements by a factor of up to 10¹⁴ to 10¹⁶, but only for certain molecules (for example, dye molecules, adenine, hemoglobin, and tyrosine), which is near the range of single molecule detection (see Kneipp et al., Physical Review E, 57 (6): R6281-R6284 (1998); Nie et al., Science, 275: 1102 (1997)). However, for most other molecules, enhancements using SERS techniques still remain in the range of 10³ to 10⁶ which are far below the range necessary for single molecule detection.

Coherent anti-Stokes Raman scattering (CARS) is a four-wave mixing process which uses a pump beam or wave of Raman light in combination with a Stokes beam, with center frequencies at ωₚ and ωₛ, respectively. When ωₚ-ωₛ is tuned to be resonant with a given vibrational mode in a molecule, a CARS signal of enhanced intensity is observed from the resultant scattered light at the anti-Stokes frequency of ωₚ-ωₛ. Unlike spontaneous Raman scattering, CARS is highly sensitive and can be detected in the presence of background fluorescence induced by one-photon excitation. (See Cheng et al. J Phys. Chem. 105: 1277 (2001). CARS techniques give intensity enhancement by a factor of about 10⁵ which yields cross sections in the range of about 10⁻²⁵ cm²/molecule, still too small for optical detection and spectroscopy of single molecules.

In theory, if CARS and SERS techniques were used in combination, cross sections of up to about 10⁻²¹ to 10⁻¹⁶ cm²/molecule could be consistently observed for a wide range of molecules. Enhancements in this range would consistently be in the range of single molecule detection. The combination of SERS and CARS, surface enhanced coherent anti-Stokes Raman spectroscopy (hereinafter SECARS) has been demonstrated using the metal film SERS technique (Chen et al. Phys. Rev. Lett. 43: 946 (1979); Y. R. Shen, The Principles of Non-Linear Optics, John Willey & Sons, 1984, p. 492). However, the enhancements observed using this metal film technique are not in the range that allows for single molecule detection. Enhancements using the SERS metal film technique generally are not as great as those observed for the SERS technique using suspended metal particles. In addition, to achieve SECARS enhancements by a factor of 10⁹ to 10¹⁸ or greater, the particular conditions must be finely tuned for each type of molecule.

Part of the problem in realizing these enhancements for detecting small numbers of molecules is that the ability to detect small numbers of molecules is as much a sensitivity issue as it is a background noise issue. If a particular fluorescent molecule in solution is to be detected, it must be distinguishable from the background associated with the solvent. To minimize the background contribution, the smallest possible sample volumes must be used. This is due to the fact that the background is proportional to the sample volume, while the signal from a molecule is independent of the sample volume. Raman detection of small numbers of molecules, therefore may use sample volumes of 10 pL or less. A need exists for methods of increasing signal enhancements from molecules using Raman spectroscopy and devices for using SECARS to detect small numbers of molecules.

### BRIEF DESCRIPTION OF THE DRAWINGS

In order that the invention may be better understood, several embodiments thereof will now be described by way of example only and with reference to the accompanying drawings in which:

FIG. 1 is a schematic of a synchronized SECARS system which uses various optics to focus the beams and also to collect the Raman scattered light from the sample in accordance with one embodiment of the invention;

FIG. 2 shows the region of the sample cell of FIG. 1. The scale of the drawing is such that the Raman-active surfaces are positioned within tens of nanometers from the analyte to allow for the enhancements of the present invention;

FIG. 3 is a SECARS spectrum of deoxy-adenosine monophosphate (dAMP) at 100 nanomolar concentration. This corresponds to about 1000 molecules of dAMP. A represents the SECARS signal of dAMP at 730 cm⁻¹ (which corresponds to 742 nm with a 785 nm pump laser) and generates about 70,000 counts. B represents the pump laser signal at 785 nm. C represents the Stoke laser signal at 833 nm. The spectrum was collected for 100 milliseconds. The pump and Stokes lasers are pulsed at ˜2 picoseconds. The average power of the pump laser was ˜500 mW, and the average power of the Stokes laser was ˜300 mW.

FIG. 4 is a comparative SERS spectrum of deoxy-adenosine monophosphate (dAMP) at the same 100 nanomolar concentration. A represents the SERS signal of dAMP is at 730 cm⁻¹ (which corresponds to 833 nm with a 785 nm pump laser) and generates only about 1,500 counts. The spectrum was collected for 100 milliseconds. The pump laser operated in continuous-wave mode. The average power of the pump laser was at ˜500 mW, and the Stokes laser was not used.

FIG. 5 is a comparative CARS spectrum of deoxy-adenosine monophosphate (dAMP) also at 100 millimolar concentration. A represents the CARS signal of dAMP at 730 cm⁻¹ (which corresponds to 742 nm with 785 nm pump laser) generates about 2,500 counts. B represents the pump laser signal at 785 nm. C represents the Stoke laser signal at 833 nm. The spectrum was also collected for 100 milliseconds. The pump and Stokes lasers were pulsed at ˜2 picoseconds. The average power of the pump laser was ˜500 mW, and the average power of the Stokes laser was ˜300 mW. The CARS spectrum of 100 nanomolar dAMP could not be obtained with 100 millisecond spectral collection time.

FIG. 6 shows the SECARS signal from dAMP and dGMP at 90 pM concentration.

FIG. 7 shows the SECARS signal from angiotensin I peptide at 90 ng/μL concentration.

### DETAILED DESCRIPTION OF THE INVENTION

Definitions

For the purposes of the present disclosure, the following terms have the following meanings. Terms not defined are used according to their plain and ordinary meaning.

As used herein, “a” or “an” may mean one or more than one of an item.

As used herein, “about” means within ten percent of a value. For example, “about 100” would mean a value between 90 and 110.

As used herein, a “multiplicity” of an item means two or more of the item.

As used herein, a “microchannel” is any channel with a cross-sectional diameter of between 1 micrometer (μm) and 999 μm, while a “nanochannel” is any channel with a cross-sectional diameter of between 1 nanometer (nm) and 999 nm. In certain embodiments of the invention, a “nanochannel or microchannel” may be about 999 μm or less in diameter. A “microfluidic channel” is a channel in which liquids may move by microfluidic flow. The effects of channel diameter, fluid viscosity and flow rate on microfluidic flow are known in the art.

As used herein, “operably coupled” means that there is a functional interaction between two or more units of an apparatus and/or system. For example, a Raman detector 195 may be “operably coupled” to a flow through cell (sample cell) 175, nanochannel, microchannel, or microfluidic channel 185, if the Raman detector 195 is arranged so that it can detect single molecule analytes 210, such as nucleotides, as they pass through the sample cell 175, nanochannel, microchannel, or microfluidic channel, 185. Also for example a Raman detector 195 may be “operably coupled” to a computer 200 if the computer 200 can obtain, process, store and/or transmit data on Raman signals detected by the Raman detector.

As used herein, the term “analyte” 210 means any atom, chemical, molecule, compound, composition or aggregate of interest for detection and/or identification. Examples of analytes include, but are not limited to, an amino acid, peptide, polypeptide, protein, glycoprotein, lipoprotein, nucleoside, nucleotide, oligonucleotide, nucleic acid, sugar, carbohydrate, oligosaccharide, polysaccharide, fatty acid, lipid, hormone, metabolite, cytokine, chemokine, receptor, neurotransmitter, antigen, allergen, antibody, substrate, metabolite, cofactor, inhibitor, drug, pharmaceutical, nutrient, prion, toxin, poison, explosive, pesticide, chemical warfare agent, biohazardous agent, radioisotope, vitamin, heterocyclic aromatic compound, carcinogen, mutagen, narcotic, amphetamine, barbiturate, hallucinogen, waste product and/or contaminant. In certain embodiments of the invention, one or more analytes may be labeled with one or more Raman labels, as disclosed below.

The term “label” is used to refer to any atom, molecule, compound or composition that can be used to identify an analyte 210 to which the label is attached. In various embodiments of the invention, such attachment may be either covalent or non-covalent. In non-limiting examples, labels may be fluorescent, phosphorescent, luminescent, electroluminescent, chemiluminescent or any bulky group or may exhibit Raman or other spectroscopic characteristics.

A “Raman label” may be any organic or inorganic molecule, atom, complex or structure capable of producing a detectable Raman signal, including but not limited to synthetic molecules, dyes, naturally occurring pigments such as phycoerythrin, organic nanostructures such as C₆₀, buckyballs and carbon nanotubes, metal nanostructures such as gold or silver nanoparticles or nanoprisms and nano-scale semiconductors such as quantum dots. Numerous examples of Raman labels are disclosed below. A person of ordinary skill in the art will realize that such examples are not limiting, and that “Raman label” encompasses any organic or inorganic atom, molecule, compound or structure known in the art that can be detected by Raman spectroscopy.

As used herein, the term “nanocrystalline silicon” refers to silicon that comprises nanometer-scale silicon crystals, typically in the size range from 1 to 100 nanometers (nm). “Porous silicon” 220 refers to silicon that has been etched or otherwise treated to form a porous structure.

Surface-Enhanced Coherent Anti-Stokes Raman Spectroscopy

One embodiment of the invention relates to a device and a method of detecting a small numbers of molecules by using Surface Enhanced Coherent Anti-Stokes Raman Spectroscopy (hereinafter “SECARS”)—a combination of Surface Enhanced Raman Spectroscopy (hereinafter “SERS”) with Coherent Anti-Stokes Raman Scattering (hereinafter “CARS”). The device and method of the invention involves launching both a Stokes light and a pump light of different Raman wavelengths at a target area defined by the interface between the molecules to be detected and/or identified and a Raman active surface. Small numbers of molecules include less than about 10⁷, preferably less than about 10⁶, preferably less than about 10⁵, preferably less than about 10⁴, preferably less than about 10³, preferably less than about 10², preferably less than about 10, preferably less than 5, preferably one molecule, and ranges there between. In one embodiment, a Raman active surface is operably coupled to one or more Raman detection units 195.

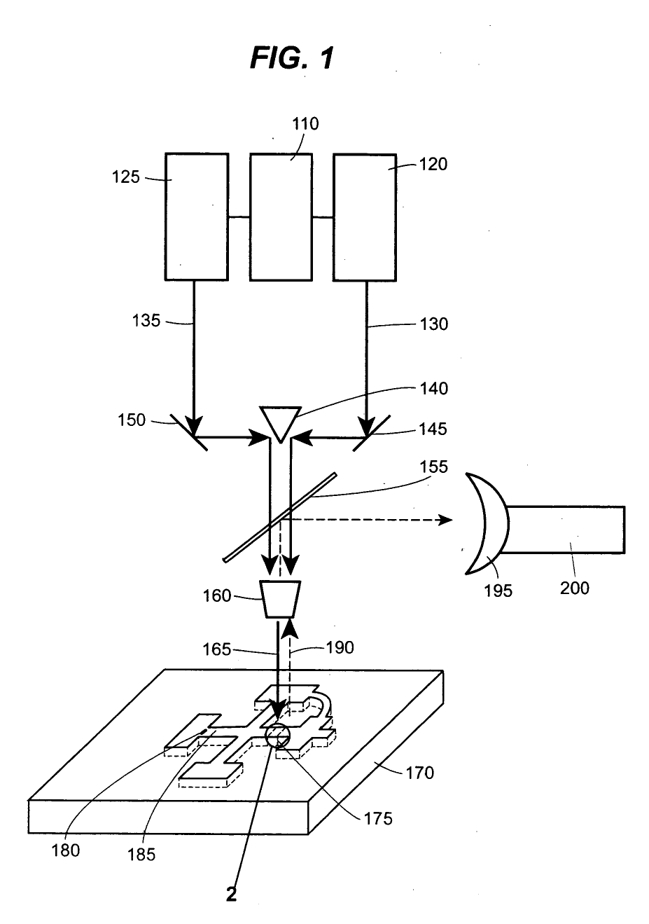

Referring to FIG. 1, in one embodiment, the device provides two input excitation beams or waves 130 and 135 of electromagnetic radiation from sources 120 and 125, respectively. These sources may individually comprise an ordinary light source, with suitable filters and collimators, or preferably, these sources are provided by two diode lasers, solid-state lasers, ion lasers, or the like. These lasers may be of any particular size; however, because it is desirable to practice the methods of the invention as part of a microdevice, the use of microlasers is preferred. Suitable sources include, but are not limited to, a 514.5 nm line argon-ion laser from SpectraPhysics, Model 166, a 647.1 nm line of a krypton-ion laser (Innova 70, Coherent); a nitrogen laser at 337 nm (Laser Science Inc.); a helium-cadmium laser at 325 nm (Liconox; See U.S. Pat. No. 6,174,677); an Nd:YLF laser, and/or various ions lasers and/or dye lasers; vertical-cavity surface emitting lasers (“VCSEL”) (Honeywell, Richardson, Tex.; or Schott, Southbridge, Mass.); other microlasers such as nanowire lasers (See Huang et al. Science 292: 1897 (2001)); a frequency doubled Nd:YAG laser at 532 nm wavelength or a frequency doubled Ti:sapphire laser 370 at any wavelength between 700 nm and 1000 nm; or a light emitting diode.

The signal strength of surface enhanced CARS depends on the strength of the input pump beam; however, the maximum laser intensity on the interface is often limited by optical damage. For this reason, it is preferable to use a shorter pump pulsed laser beam which has a high peak power than a typical continuous-wave laser beam. Continuous wave (“CW”) lasers typically provide microwatts to a watt at high peak power levels, whereas pulsed lasers provide kilowatts to gigawatts at high peak power levels when operated at the same average power. This yields stronger signals which remain below the optical damage threshold. The width of the pulses ranges from about 100 nanoseconds to about 80 femtoseconds. Typically, the pulse widths of from about 100 femtoseconds to about seven picoseconds yield the best results, depending on the peak power and the spectral line width of the beam.

Pulsed laser beams or CW laser beams may be used. When a laser is used, the input beams must also be synchronized to guarantee overlap of the beams. This may be accomplished by a suitable laser controller or other type of synchronization electronics, 110. Examples of commercially available electronics that may be used include, but are not limited to, a Lok-to-Clock device (Spectra-Physics) or a SynchroLock device (Coherent). These electronic devices may require additional photodiodes and beamsplitters for their operation, which are not depicted in the Figures. An alternative embodiment uses an optical parametric oscillator (OPO), which takes a single laser beam input and generates two synchronized beams at different tunable wavelengths.

The wave vector of the pump wave can be adjusted to satisfy the surface phase-matching condition:
2k₁−k₂=kₐ(ωₐ)=K′(ωₐ)
wherein k₁ is the wavevector of the first beam; k₂ is the wavevector of the second beam; kₐ (ωₐ) is the wavevector of the anti-Stokes signal; and K′(ωₐ) is the wavevector of the surface EM wave.

There are several ways to deliver these two beams of light to the sample. As depicted in FIG. 1, one embodiment of a SECARS device may use either standard full field optics or confocal optics, such as a series of mirrors 145 and 150, and dichoric mirror 155 and/or prisms 140 to direct the input beams 130 and 135 into the sample cell. The beams may be focused through a hemicylindrical (right-angle or equilateral) or objective lens 160, made of a transparent material such as glass or quartz. Examples of such focusing lenses include, but are not limited to, microscope objective lenses available from Nikon, Zeiss, Olympus, and Newport, such as a 6× objective lens (Newport, Model L6× ) or 100× objective lens (Nikon, Epi 100× achromat). The focusing lens 160 is used to focus the excitation beams onto the area containing the Raman active surface and the analyte and also to collect the Raman scattered light from the sample.

These beams may optionally pass through other devices which change the properties of the beams or reduce the background signal, such as a polarizer, a slit, additional lenses, a holographic beam splitter and/or notch filter, monochromator, dichroic filters, bandpass filters, mirrors, barrier filters, and confocal pinholes, or the like. For example, a holographic beam splitter (Kaiser Optical Systems, Inc., Model HB 647-26N 18) produces a right-angle geometry for the excitation beam 135 and the emitted Raman signal. A holographic notch filter (Kaiser Optical Systems, Inc.) may be used to reduce Rayleigh scattered radiation. Likewise, the excitation beam(s) 130 and 135 may be spectrally purified, for example with a bandpass filter (Corion).

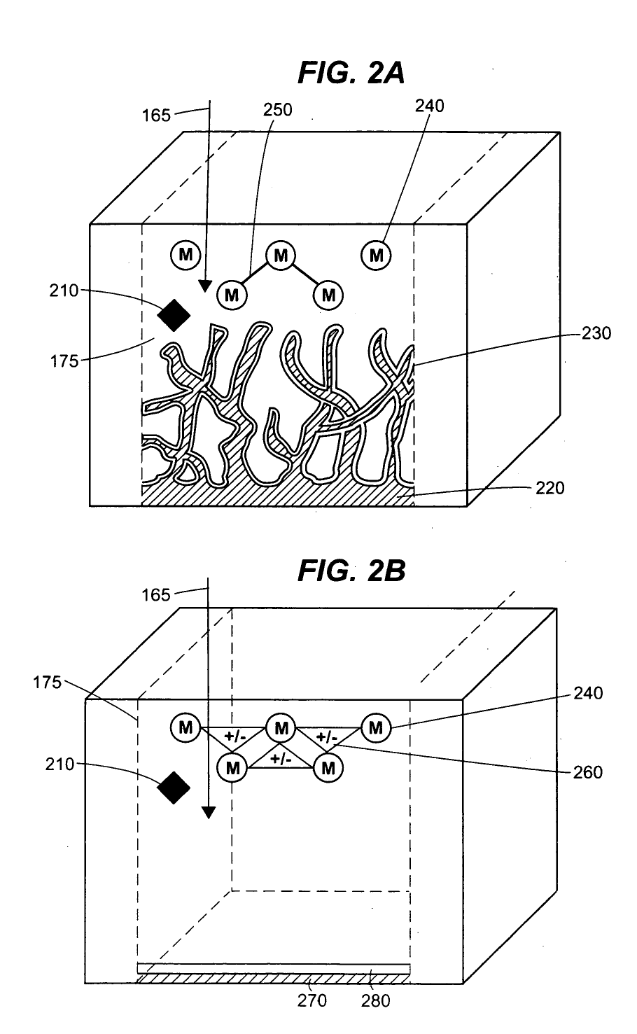

The focusing lens focuses the light 165 into an optically transmissive sample cell 175 which is shown in greater detail in FIGS. 2A and B. As depicted in FIGS. 2A and B the light is focused into a region which contains an interface between the analyte to be detected, generally shown as 210, and a Raman active surface, which are described in more detail below.

Certain embodiments of the invention concern using Raman surfaces of various forms. For example, Raman active surfaces include, but are not limited to: a metallic surface, 220 and 230, or 270 and 280, such as one or more layers of nanocrystalline and/or porous silicon coated with a metal or other conductive material; a particle 240, such as a metallic nanoparticle; an aggregate of particles 250, such as a metallic nanoparticle aggregate; a colloid of particles (240 with ionic compounds 260), such as a metallic nanoparticle colloid; or combinations thereof.

The anti-Stokes beam of radiation 190 emitted from the interface between the analyte and the Raman active surface passes out of the sample cell and travels as a coherent beam that is collected by the confocal or standard optics and optionally coupled to a monochromator for spectral dissociation. The beam is detected with a Raman detector unit 195. The highly directional output of the anti-Stokes beam allows for its detection even in the presence of a strongly luminescent background.

Raman Detection Unit

The Raman detection unit is not especially important and can be any generic optical detector with sufficient sensitivity and speed to detect small numbers of molecules of a particular analyte. Sensitivity comparable to that of cooled, charge coupled device (“CCD”) arrays is sufficient. The speed of detection is within milliseconds to nanoseconds in range. The Raman detection unit may comprise a large or small area detector, an array of detectors, or the like. Examples of such detectors include photodiodes, avalanche-photodiodes, CCD arrays, complementary metal oxide semiconductor (CMOS) arrays, intensified CCDs, and the like. CCD, CMOS, and avalanche photodiodes are preferred. The differential detector 195 generates electrical output signals indicative of the variation of intensity of light with position across the anti-Stokes wave or beam 190; the SECARS effect dictating that strong absorption will occur at a particular angle or intensity as determined by material in the sample being tested. These electrical signals are sampled/counted and digitized and fed via associated circuitry (not shown) to a suitable data analyzing arrangement (collectively, 200) which may include an information processing and control system or computer.

Examples of a Raman detection unit 195 include, but are not limited to, a Spex Model 1403 double-grating spectrophotometer with a gallium-arsenide photomultiplier tube operated as a single-photon counting model (RCA Model C31034 or Burle Indus. Model C3103402; See U.S. Pat. No. 5,306,403); an ISA HR-320 spectrograph equipped with a red-enhanced intensified charge-coupled device (RE-ICCD) detection system (Princeton Instruments); Fourier-transform spectrographs (based on Michaelson interferometers), charged injection devices; photodiode arrays, including avalance photodiode arrays; InGaAs detectors; electron-multiplied CCD; intensified CCD and/or phototransistor arrays.

Information Processing and Control System or Computer and Data Analysis

In certain embodiments of the invention, the apparatus may comprise an information processing system or computer 200. The disclosed embodiments are not limiting for the type of information processing system or computer 200 used. An exemplary information processing system or computer may comprise a bus for communicating information and a processor for processing information. In one embodiment of the invention, the processor is selected from the Pentium® family of processors, including without limitation the Pentium® III family, the Pentium® III family and the Pentium® 4 family of processors available from Intel Corp. (Santa Clara, Calif.). In alternative embodiments of the invention, the processor may be a Celeron®, an Itanium®, or a Pentium Xeon® Processor (Intel Corp., Santa Clara, Calif.). In various other embodiments of the invention, the processor may be based on Intel® architecture, such as Intel® IA-32 or Intel®IA-64 architecture. Alternatively, other processors may be used.

The information processing and control system or computer 200 may further comprise a random access memory (RAM) or other dynamic storage device, a read only memory (ROM) or other static storage and a data storage device such as a magnetic disk or optical disc and its corresponding drive. The information processing and control system or computer 200 may further comprise any peripheral devices known in the art, such as memory, a display device (e.g., cathode ray tube or Liquid Crystal Display (LCD)), an alphanumeric input device (e.g., keyboard), a cursor control device (e.g., mouse, trackball, or cursor direction keys) and a communication device (e.g., modem, network interface card, or interface device used for coupling to Ethernet, token ring, or other types of networks).

Data from the detection unit 195 may be processed by the processor and data stored in the memory, such as the main memory. Data on emission profiles for standard analytes may also be stored in memory, such as main memory or in ROM. The processor may compare the emission spectra from the sample of analyte molecules 210 and the Raman active surface to identify the type of analyte(s) in the sample(s). For example, the information processing system may perform procedures such as subtraction of background signals and “base-calling” determination when overlapping signals are detected as part of nucleotide identification. It is appreciated that a differently equipped computer 200 may be used for certain implementations. Therefore, the configuration of the system may vary in different embodiments of the invention.

While the methods disclosed herein may be performed under the control of a programmed processor, in alternative embodiments of the invention, the processes may be fully or partially implemented by any programmable or hardcoded logic, such as Field Programmable Gate Arrays (FPGAs), TTL logic, or Application Specific Integrated Circuits (ASICs), for example. Additionally, the disclosed methods may be performed by any combination of programmed general purpose computer 200 components and/or custom hardware components.

Following the data gathering operation, the data will typically be reported to a data analysis operation. To facilitate the analysis operation, the data obtained by the detection unit 195 will typically be analyzed using a digital computer such as that described above. Typically, the computer will be appropriately programmed for receipt and storage of the data from the detection unit 195 as well as for analysis and reporting of the data gathered.

In certain embodiments of the invention, custom designed software packages may be used to analyze the data obtained from the detection unit 195. In alternative embodiments of the invention, data analysis may be performed, using an information processing system or computer 200 and publicly available software packages. Non-limiting examples of available software for DNA sequence analysis include the PRISM™ DNA Sequencing Analysis Software (Applied Biosystems, Foster City, Calif.), the Sequencher™ package (Gene Codes, Ann Arbor, Mich.), and a variety of software packages available through the National Biotechnology Information Facility at website www.nbif.org/links/1.4.1.php.

Raman-Active Surfaces

A. Nanoparticles, Aggregates, and Colloids

In certain embodiments of the invention, the Raman active surface is provided by metal nanoparticles, 240, which may used alone or in combination with other Raman active surfaces, such as a metal-coated porous silicon substrate 220 with 230 to further enhance the Raman signal obtained from small numbers of molecules of an analyte 210. In various embodiments of the invention, the nanoparticles are silver, gold, platinum, copper, aluminum, or other conductive materials, although any nanoparticles capable of providing a SECARS signal may be used. Particles made of silver or gold are especially preferred.

The particles or colloid surfaces can be of various shapes and sizes. In various embodiments of the invention, nanoparticles of between 1 nanometer (nm) and 2 micrometers (μm) in diameter may be used. In alternative embodiments of the invention, nanoparticles of 2 nm to 1 μm, 5 nm to 500 nm, 10 nm to 200 nm, 20 nm to 100 nm, 30 nm to 80 nm, 40 nm to 70 nm or 50 nm to 60 nm diameter may be used. In certain embodiments of the invention, nanoparticles with an average diameter of 10 to 50 nm, 50 to 100 nm or about 100 nm may be used. If used in combination with another Raman active surface, such as a metal-coated porous silicon substrate, the size of the nanoparticles will depend on the other surface used. For example, the diameter of the pores in the metal-coated porous silicon 220 with 230 and may be selected so that the nanoparticles fit inside the pores.

The nanoparticles may be approximately spherical, cylindrical, triangular, rod-like, edgy, multi-faceted, prism, or pointy in shape, although nanoparticles of any regular or irregular shape may be used. Methods of preparing nanoparticles are known (see e.g., U.S. Pat. Nos. 6,054,495; 6,127,120; 6,149,868; Lee and Meisel, J. Phys. Chem. 86: 3391-3395, 1982). Nanoprisms are described in Jin et al., “Photoinduced conversion of silver nanospheres to nanoprisms,” Science 294: 1901, 2001. Nanoparticles may also be obtained from commercial sources (e.g., Nanoprobes Inc., Yaphank, N.Y.; Polysciences, Inc., Warrington, Pa.).

Colloids and Aggregates

In certain embodiments of the invention, the nanoparticles may be single nanoparticles 240, and/or random colloids of nanoparticles (240 with ionic compounds 260). Colloids of nanoparticles are synthesized by standard techniques, such as by adding ionic compounds 260, such as NaCl, to the nanoparticles 240 (See Lee and Meisel, J. Phys. Chem 86: 3391 (1982); J. Hulteen, et al., “Nanosphere Lithography: A materials general fabrication process for periodic particle array surfaces,” J. Vac. Sci. Technol. A 13: 1553-1558 (1995)).

The aggregation can be induced by the “depletion mechanism,” wherein the addition of non-adsorbing nanoparticles effectively results in an attraction potential due to the depletion of the nanoparticles from the region between two closely approaching nanoparticles (See J. Chem. Phys., 110(4): 2280 (1999).)

In other embodiments of the invention, nanoparticles 240 may be cross-linked to produce particular aggregates of nanoparticles 250, such as dimers, trimers, tetramers or other aggregates. Formation of “hot spots” for SECARS detection may be associated with particular aggregates 250 or colloids (240 with ionic compounds 260) of nanoparticles. Certain embodiments of the invention may use heterogeneous mixtures of aggregates or colloids of different size, while other embodiments may use homogenous populations of nanoparticles 240 and/or aggregates 250 or colloids (240 with ionic compounds 260). In certain embodiments of the invention, aggregates containing a selected number of nanoparticles 250 (dimers, trimers, etc.) may be enriched or purified by known techniques, such as ultracentrifugation in sucrose gradient solutions. In various embodiments of the invention, nanoparticle aggregates 250 or colloids (240 with ionic compounds 260) of about 100, 200, 300, 400, 500, 600, 700, 800, 900 to 100 nm in size or larger are used. In particular embodiments of the invention, nanoparticle aggregates 250 or colloids (240 with ionic compounds 260) may be between about 100 nm and about 200 nm in size.

Methods of cross-linking nanoparticles to form aggregates are also known in the art (see, e.g., Feldheim, “Assembly of metal nanoparticle arrays using molecular bridges,” The Electrochemical Society Interface, Fall, 2001, pp. 22-25). For example, gold nanoparticles may be cross-linked, for example, using bifunctional linker compounds bearing terminal thiol or sulfhydryl groups (Feldheim, 2001). In some embodiments of the invention, a single linker compound may be derivatized with thiol groups at both ends. Upon reaction with gold nanoparticles, the linker would form nanoparticle dimers that are separated by the length of the linker. In other embodiments of the invention, linkers with three, four or more thiol groups may be used to simultaneously attach to multiple nanoparticles (Feldheim, 2001). The use of an excess of nanoparticles to linker compounds prevents formation of multiple cross-links and nanoparticle precipitation. Aggregates of silver nanoparticles may also be formed by standard synthesis methods known in the art.

In other embodiments of the invention, the nanoparticles 240 aggregates 250, or colloids (240 with ionic compounds 260), may be covalently attached to a molecular sample of an analyte 210. In alternative embodiments of the invention, the molecular sample of the analyte 210 may be directly attached to the nanoparticles 240, or may be attached to linker compounds that are covalently or non-covalently bonded to the nanoparticles aggregates 250.

Various methods known for cross-linking nanoparticles may also be used to attach molecule(s) of an analyte 210 to nanoparticles or other Raman-active surfaces. It is contemplated that the linker compounds used to attach molecule(s) of an analyte 210 may be of almost any length, ranging from about 0.05, 0.1, 0.2, 0.5, 0.75, 1, 2, 3, 4, 5, 6, 7, 8, 9, 10, 11, 12, 13, 14, 15, 16, 17, 18, 19, 20, 21, 22, 23, 24, 25, 27, 30, 35, 40, 45, 50, 55, 60, 65, 60, 80, 90 to 100 nm or even greater length. Certain embodiments of the invention may use linkers of heterogeneous length.

In one embodiment of the invention disclosed in, the molecule(s) of an analyte 210 may be attached to nanoparticles 240 as they travel down a channel 185 to form molecular-nanoparticle complex. In certain embodiments of the invention, the length of time available for the cross-linking reaction to occur may be very limited. Such embodiments may utilize highly reactive cross-linking groups with rapid reaction rates, such as epoxide groups, azido groups, arylazido groups, triazine groups or diazo groups. In certain embodiments of the invention, the cross-linking groups may be photoactivated by exposure to intense light, such as a laser. For example, photoactivation of diazo or azido compounds results in the formation, respectively, of highly reactive carbene and nitrene moieties. In certain embodiments of the invention, the reactive groups may be selected so that they can only attach the nanoparticles 240 to an analyte 210, rather than cross-linking the nanoparticles 240 to each other. The selection and preparation of reactive cross-linking groups capable of binding to an analyte 210 is known in the art. In alternative embodiments of the invention, analytes 210 may themselves be covalently modified, for example with a sulfhydryl group that can attach to gold nanoparticles 240.

In other embodiments of the invention, the nanoparticles or other Raman active surfaces may be coated with derivatized silanes, such as aminosilane, 3-glycidoxypropyltrimethoxysilane (GOP) or aminopropyltrimethoxysilane (APTS). The reactive groups at the ends of the silanes may be used to form cross-linked aggregates of nanoparticles 240. It is contemplated that the linker compounds used may be of almost any length, ranging from about 0.05, 0.1, 0.2, 0.5, 0.75, 1, 2, 3, 4, 5, 6, 7, 8, 9, 10, 11, 12, 13, 14, 15, 16, 17, 18, 19, 20, 21, 21, 22, 23, 24, 25, 27, 30, 35, 40, 45, 50, 55, 60, 65, 70, 80, 90, to 100 nm or even greater length. Certain embodiments of the invention may use linkers of heterogeneous length. Such modified silanes may also be covalently attached to analytes 210 using standard methods.

In another alternative embodiment of the invention, the nanoparticles may be modified to contain various reactive groups before they are attached to linker compounds. Modified nanoparticles are commercially available, such as the Nanogold® nanoparticles from Nanoprobes, Inc. (Yaphank, N.Y.). Nanogold® nanoparticles may be obtained with either single or multiple maleimide, amine or other groups attached per nanoparticle. The Nanogold® nanoparticles are also available in either positively or negatively charged form to facilitate manipulation of nanoparticles in an electric field. Such modified nanoparticles may be attached to a variety of known linker compounds to provide dimers, trimers or other aggregates of nanoparticles.

The type of linker compound used is not limiting, so long as it results in the production of small aggregates of nanoparticles 250 and/or analytes that will not precipitate in solution. In some embodiments of the invention, the linker group may comprise phenylacetylene polymers (Feldheim, 2001). Alternatively, linker groups may comprise polytetrafluoroethylene, polyvinyl pyrrolidone, polystyrene, polypropylene, polyacrylamide, polyethylene or other known polymers. The linker compounds of use are not limited to polymers, but may also include other types of molecules such as silanes, alkanes, derivatized silanes or derivatized alkanes. In particular embodiments of the invention, linker compounds of relatively simple chemical structure, such as alkanes or silanes, may be used to avoid interfering with the Raman signals emitted by an analyte.

Alternatively, the linker compounds used may contain a single reactive group, such as a thiol group. Nanoparticles containing a single attached linker compound may self-aggregate into dimers, for example, by non-covalent interaction of linker compounds attached to two different nanoparticles. For example, the linker compounds may comprise alkane thiols. Following attachment of the thiol group to gold nanoparticles, the alkane groups will tend to associate by hydrophobic interaction. In other alternative embodiments of the invention, the linker compounds may contain different functional groups at either end. For example, a liker compound could contain a sulfydryl group at one end to allow attachment to gold nanoparticles, and a different reactive group at the other end to allow attachment to other linker compounds. Many such reactive groups are known in the art and may be used in the present methods and apparatus.

In other embodiments of the invention, an analyte 210 is closely associated with the surface of the nanoparticles 240 or may be otherwise in close proximity to the nanoparticles 240 (between about 0.2 and 1.0 nm). As used herein, the term “closely associated with” refers to a molecular sample of an analyte which is attached (either covalent or non-covalent) or adsorbed on a Raman-active surface. The skilled artisan will realize that covalent attachment of a molecular sample of an analyte 210 to nanoparticles 240 is not required in order to generate a surface-enhanced Raman signal by SECARS.

b. Metal Coated- and Non-Metal Coated Nanocrystalline and/or Porous Silicon

Various methods for producing rough or high-surface area surfaces, such as nanocrystalline silicon, are known in the art (e.g., Petrova-Koch et al., “Rapid-thermal-oxidized porous silicon—the superior photoluminescent Si,” Appl. Phys. Lett. 61: 943, 1992; Edelberg, et al., “Visible luminescence from nanocrystalline silicon films produced by plasma enhanced chemical vapor deposition,” Appl. Phys. Lett., 68: 1415-1417, 1996; Schoenfeld, et al., “Formation of Si quantum dots in nanocrystalline silicon,” Proc. 7th Int. Conf. on Modulated Semiconductor Structures, Madrid, pp. 605-608, 1995; Zhao, et al., “Nanocrystalline Si: a material constructed by Si quantum dots,” 1st Int. Conf. on Low Dimensional Structures and Devices, Singapore, pp. 467-471, 1995; Lutzen et al., “Structural characteristics of ultrathin nanocrystalline silicon films formed by annealing amorphous silicon”, J. Vac. Sci. Technology B 16: 2802-05, 1998; U.S. Pat. Nos. 5,770,022; 5,994,164; 6,268,041; 6,294,442; 6,300,193). The methods and apparatus disclosed herein are not limited by the method of producing rough or high-surface area substrates and it is contemplated that any known method may be used.

For example, methods for producing nanocrystalline silicon include, but are not limited to, silicon (Si) implantation into a silicon rich oxide and annealing; solid phase crystallization with metal nucleation catalysts; chemical vapor deposition; PECVD (plasma enhanced chemical vapor deposition); gas evaporation; gas phase pyrolysis; gas phase photopyrolysis; electrochemical etching; plasma decomposition of silanes and polysilanes; high pressure liquid phase reduction-oxidation reactions; rapid annealing of amorphous silicon layers; depositing an amorphous silicon layer using LPCVD (low pressure chemical vapor deposition) followed by RTA (rapid thermal anneal) cycles; plasma electric arc deposition using a silicon anode and laser ablation of silicon (U.S. Pat. Nos. 5,770,022; 5,994,164; 6,268,041; 6,294,442; 6,300,193). Depending on the process, Si crystals of anywhere from 1 to 100 nm or more in size may be formed as a thin layer on a chip, a separate layer and/or as aggregated crystals. In certain embodiments of the invention, a thin layer comprising nanocrystalline silicon attached to a substrate layer 220 may be used.

However, the embodiments are not limited to as to the composition of the starting material, and in alternative embodiments of the invention it is contemplated that other materials may be utilized, the only requirement being that the material must be capable of forming substrate 220 or 270 that can be coated with a Raman sensitive metal, as exemplified in FIG. 2.

In certain embodiments of the invention, the size and/or shape of silicon crystals and/or pore size in porous silicon may be selected to be within predetermined limits, for example, in order to optimize the plasmon resonant frequency of metal-coated porous silicon, 220 with 230, (see, e.g., U.S. Pat. No. 6,344,272). The plasmon resonant frequency may also be adjusted by controlling the thickness of the metal layer 230 coating the porous silicon 220 (U.S. Pat. No. 6,344,272). Techniques for controlling the size of nano-scale silicon crystals are known (e.g., U.S. Pat. Nos. 5,994,164 and 6,294,442).

1. Porous Silicon

As discussed above, the rough surface substrate 220 is not limited to pure silicon, but may also comprise silicon nitride, germanium and/or other materials known for chip manufacture. Other minor amounts of material may also be present, such as metal nucleation catalysts and/or dopants. The only requirement is that the substrate material must be capable of forming a substrate 220 or 270 that can be coated with a Raman sensitive metal or other conductive or semiconductive material 230 or 280, as exemplified in FIG. 2. Porous silicon has a large surface area of up to 783 m² μm³, providing a very large surface for surface enhanced Raman spectroscopy techniques.

As is known in the art, porous silicon 220 may be produced by etching of a silicon substrate with dilute hydrofluoric acid (HF) in an electrochemical cell. In certain cases, silicon may be initially etched in HF at low current densities. After the initial pores are formed, the silicon may be removed from the electrochemical cell and etched in very dilute HF to widen the pores formed in the electrochemical cell. The composition of the silicon substrate will also affect pore size, depending on whether or not the silicon is doped, the type of dopant and the degree of doping. The effect of doping on silicon pore size is known in the art. For embodiments of the invention involving detection and/or identification of large biomolecules, a pore size of about 2 nm to 100 or 200 nm may be selected. The orientation of pores in porous silicon may also be selected in particular embodiments of the invention. For example, an etched 1,0,0 crystal structure will have pores oriented perpendicular to the crystals, while 1,1, 1 or 1,1,0 crystal structures will have pores oriented diagonally along the crystal axis. The effect of crystal structure on pore orientation is also known in the art. Crystal composition and porosity may also be regulated to change the optical properties of the porous silicon in order to enhance the Raman signals and decrease background noise. Optical properties of porous silicon are well known in the art (e.g., Cullis et al., J. Appl. Phys. 82: 909-965, (1997); Collins et al., Physics Today 50: 24-31, (1997)).

In various embodiments of the invention, portions of the silicon wafer may be protected from HF etching by coating with any known resist compound, such as polymethyl-methacrylate. Lithography methods, such as photolithography, of use for exposing selected portions of a silicon wafer to HF etching are well known in the art. Selective etching may be of use to control the size and shape of a porous Si chamber to be used for Raman spectroscopy. In certain embodiments of the invention, a porous silicon chamber of about 1 μm (micrometer) in diameter may be used. In other embodiments of the invention, a trench or channel of porous silicon of about 1 μm in width may be used. The size of the porous silicon chamber is not limiting, and it is contemplated that any size or shape of porous silicon chamber may be used. A 1 μm chamber size may be of use, for example, with an excitatory laser that is 1 μm in size.

The exemplary method disclosed above is not limiting for producing porous silicon substrates 220 and it is contemplated that any method known in the art may be used. Non-limiting examples of methods for making porous silicon substrates 220 include anodic etching of silicon wafers or meshes; electroplating; and depositing a silicon/oxygen containing material followed by controlled annealing; (e.g., Canham, “Silicon quantum wire array fabrication by electrochemical and chemical dissolution of wafers,” Appl. Phys. Lett. 57: 1046, 1990; U.S. Pat. Nos. 5,561,304; 6,153,489; 6,171,945; 6,322,895; 6,358,613; 6,358,815; 6,359,276). In various embodiments of the invention, the porous silicon layer 220 may be attached to one or more supporting layers, such as bulk silicon, quartz, glass and/or plastic. In certain embodiments, an etch stop layer, such as silicon nitride, may be used to control the depth of etching.

In certain alternative embodiments of the invention, it is contemplated that additional modifications to the porous silicon substrate 220 may be made, either before or after metal coating 230. For example, after etching a porous silicon substrate 220 may be oxidized, using methods known in the art, to silicon oxide and/or silicon dioxide. Oxidation may be used, for example, to increase the mechanical strength and stability of the porous silicon substrate 220. Alternatively, the metal-coated silicon substrate 220 with 230 may be subjected to further etching to remove the silicon material, leaving a metal shell that may be left hollow or may be filled with other materials, such as additional Raman active metal.

2. Metal Coating of Silicon Substrates

The silicon substrate 220 or 270 may be coated with a Raman active metal, such as gold, silver, platinum, copper or aluminum, by any method known in the art. Non-limiting exemplary methods include electroplating; cathodic electromigration; evaporation and sputtering of metals; using seed crystals to catalyze plating (i.e. using a copper/nickel seed to plate gold); ion implantation; diffusion; or any other method known in the art for plating thin metal layers on a silicon substrate 220 or 270. (See, e.g., Lopez and Fauchet, “Erbium emission form porous silicon one-dimensional photonic band gap structures,” Appl. Phys. Lett. 77: 3704-6, (2000); U.S. Pat. Nos. 5,561,304; 6,171,945; 6,359,276.) Another non-limiting example of metal coating comprises electroless plating (e.g., Gole et al., “Patterned metallization of porous silicon from electroless solution for direct electrical contact,” J. Electrochem. Soc. 147: 3785, (2000)). The composition and/or thickness of the metal layer may be controlled to optimize the plasmon resonance frequency of the metal-coated silicon 220 with 230 or 270 with 280.

In alternative embodiments of the invention, the Raman active surfaces used for analyte detection may comprise combinations of different types of Raman-active surfaces selected such as, a metal-coated, nanocrystalline, porous silicon substrate in combination with immobilized colloids of metal-coated nanocrystalline, porous silicon nanoparticles. Such a composition would have a very high surface area of Raman active metal, with relatively small channels for analytes in solution. Although this may be less favorable for large analyte molecules, such as large proteins or nucleic acids, it may provide better sensitivity and detection of small molecule analytes, such as single nucleotides or amino acids.

Flow Paths, Channels, and Micro-Electro-Mechanical Systems (MEMS)

As exemplified in FIG. 1, in certain embodiments of the invention, a molecular sample of an analyte 210 is moved down a flow path or channel, such as a microfluidic channel, nanochannel, or microchannel 185 and/or a sample cell 175, and past a detection unit 195 of the apparatus. In accordance with such embodiments, the Raman-active surfaces and analytes may be incorporated into a larger apparatus and/or system. In certain embodiments, the Raman-active surfaces may be incorporated into a micro-electro-mechanical system (MEMS).

MEMS are integrated systems comprising mechanical elements, sensors, actuators, and electronics. All of those components may be manufactured by known microfabrication techniques on a common chip, comprising a silicon-based or equivalent substrate (e.g., Voldman et al., Ann. Rev. Biomed. Eng. 1: 401-425, (1999)). The sensor components of MEMS may be used to measure mechanical, thermal, biological, chemical, optical and/or magnetic phenomena. The electronics may process the information from the sensors and control actuator components such pumps, valves, heaters, coolers, filters, etc. thereby controlling the function of the MEMS.

a. Integrated Chip Manufacture

Alternatively, in certain embodiments of the invention, the metal coated-porous silicon layer 220 with 230 or non-porous layer 270 with 280 may be incorporated as an integral part the sample cell of the MEMS semiconductor chip, using known methods of chip manufacture. In alternative embodiments, the metal-coated porous silicon 220 with 230 chamber may be cut out of a silicon wafer and incorporated into a chip and/or other device.

In addition, the electronic components of MEMS may be fabricated using integrated circuit (IC) processes (e.g., CMOS, Bipolar, or BICMOS processes). They may be patterned using photolithographic and etching methods known for computer chip manufacture. The micromechanical components may be fabricated using compatible “micromachining” processes that selectively etch away parts of the silicon wafer or add new structural layers to form the mechanical and/or electromechanical components. Basic techniques in MEMS manufacture include depositing thin films of material on a substrate, applying a patterned mask on top of the films by photolithographic imaging or other known lithographic methods, and selectively etching the films. A thin film may have a thickness in the range of a few nanometers to 100 micrometers. Deposition techniques of use may include chemical procedures such as chemical vapor deposition (CVD), electrodeposition, epitaxy and thermal oxidation and physical procedures like physical vapor deposition (PVD) and casting. Methods for manufacture of nanoelectromechanical systems may be used for certain embodiments of the invention. (See, e.g., Craighead, Science 290: 1532-36, (2000).)

b. Microfluidic Channels and Microchannels

In some embodiments of the invention, the Raman active surface may be connected to various fluid filled compartments, such as microfluidic channels, nanochannels and/or microchannels. These and other components of the apparatus may be formed as a single unit, for example in the form of a chip as known in semiconductor chips and/or microcapillary or microfluidic chips. Alternatively, the Raman active surface may be removed from a silicon wafer and attached to other components of an apparatus. Any materials known for use in such chips may be used in the disclosed apparatus, including silicon, silicon dioxide, silicon nitride, polydimethyl siloxane (PDMS), polymethylmethacrylate (PMMA), plastic, glass, quartz, etc.

In certain embodiments of the invention, it is contemplated that the channel 185 will have a diameter between about 3 nm and about 1 μm. In particular embodiments of the invention, the diameter of the channel 185 may be selected to be slightly smaller in size than an excitatory laser beam. Techniques for batch fabrication of chips are well known in the fields of computer chip manufacture and/or microcapillary chip manufacture. Such chips may be manufactured by any method known in the art, such as by photolithography and etching, laser ablation, injection molding, casting, molecular beam epitaxy, dip-pen nanolithography, CVD fabrication, electron beam or focused ion beam technology or imprinting techniques. Non-limiting examples include conventional molding with a flowable, optically clear material such as plastic or glass; photolithography and dry etching of silicon dioxide; electron beam lithography using polymethylmethacrylate resist to pattern an aluminum mask on a silicon dioxide substrate, followed by reactive ion etching; Methods for manufacture of nanoelectromechanical systems may be used for certain embodiments of the invention. (See, e.g., Craighead, Science 290: 1532-36, 2000.) Various forms of microfabricated chips are commercially available from sources such as Caliper Technologies Inc. (Mountain View, Calif.) and ACLARA BioSciences Inc. (Mountain View, Calif.).

For fluid-filled compartments that may be exposed to various single biomolecules, such as proteins, peptides, nucleic acids, nucleotides and the like, the surfaces exposed to such molecules may be modified by coating, for example to transform a surface from a hydrophobic to a hydrophilic surface and/or to decrease adsorption of molecules to a surface. Surface modification of common chip materials such as glass, silicon, quartz and/or PDMS is known in the art (e.g., U.S. Pat. No. 6,263,286). Such modifications may include, but are not limited to, coating with commercially available capillary coatings (Supelco, Bellafonte, Pa.), silanes with various functional groups such as polyethyleneoxide or acrylamide, or any other coating known in the art.

To facilitate detection of analytes 210 one embodiment of the invention comprises materials that are transparent to electromagnetic radiation at the excitation and emission frequencies used. Glass, silicon, quartz, or any other materials that are generally transparent in the frequency ranges used for Raman spectroscopy may be used. In some embodiments, the nanochannel or microchannel 185 may be fabricated from the same materials used for fabrication of the loading chamber 180 using injection molding or other known techniques. Any geometry, shape, and size are possible for the sample cell since any refraction which this component introduces can be ignored or compensated for. The arrangement is preferably such that all light rays in the convergent beams which emerge from lens 160 travel radially of the optically transmissive sample cell 175 and thus undergo no refraction. The optically transmissive sample cell 175 and channels 185 can be part of a microfluidic device such as that disclosed in Keir et al. Anal. Chem. 74: 1503-1508 (2002).

Microfabrication of microfluidic devices, including microcapillary electrophoretic devices has also been discussed in, e.g., Jacobsen et al. (Anal. Biochem, 209: 278-283 (1994)); Effenhauser et al. (Anal. Chem. 66: 2949-2953, (1994)); Harrison et al. (Science 261: 895-897, (1993)); and U.S. Pat. No. 5,904,824.

c. Nanochannels

Smaller diameter channels, such as nanochannels 185, may be prepared by known methods, including but not limited to, coating the inside of a microchannel 185 to narrow the diameter, or using nanolithography, focused electron beam, focused ion beam or focused atom laser techniques.

Fabrication of nanochannels 185 may utilize any technique known in the art for nanoscale manufacturing. The following techniques are exemplary only. Nanochannels 185 may be made, for example, using a high-throughput electron-beam lithography system (commercially available, from for example, NOVA Scientific, Inc.; Sturbridge, Mass.). Electron beam lithography may be used to write features as small as 5 nm on silicon chips. Sensitive resists, such as polymethyl-methacrylate, coated on silicon surfaces may be patterned without use of a mask. The electron beam array may combine a field emitter cluster with a microchannel amplifier to increase the stability of the electron beam, allowing operation at low currents. In some embodiments of the invention, the SoftMask™ computer control system may be used to control electron beam lithography of nanoscale features on a silicon or other chip.

In alternative embodiments of the invention, nanochannels 185 may be produced using focused atom lasers. (e.g., Bloch et al., “Optics with an atom laser beam,” Phys. Rev. Lett. 87: 123-321, (2001).) Focused atom lasers may be used for lithography, much like standard lasers or focused electron beams. Such techniques are capable of producing micron scale or even nanoscale structures on a chip. In other alternative embodiments of the invention, dip-pen nanolithography may be used to form nanochannels 103. (e.g., Ivanisevic et al., “‘Dip-Pen’ Nanolithography on Semiconductor Surfaces,” J. Am. Chem. Soc., 123: 7887-7889, (2001).) Dip-pen nanolithography uses atomic force microscopy to deposit molecules on surfaces, such as silicon chips. Features as small as 15 nm in size may be formed, with spatial resolution of 10 nm. Nanoscale channels 185 may be formed by using dip-pen nanolithography in combination with regular photolithography techniques. For example, a micron scale line in a layer of resist may be formed by standard photolithography. Using dip-pen nanolithography, the width of the line (and the corresponding diameter of the channel 185 after etching) may be narrowed by depositing additional resist compound on the edges of the resist. After etching of the thinner line, a nanoscale channel 185 may be formed. Alternatively, atomic force microscopy may be used to remove photoresist to form nanometer scale features.

In other alternative embodiments of the invention, ion-beam lithography may be used to create nanochannels 185 on a chip. (e.g., Siegel, “Ion Beam Lithography,” VLSI Electronics, Microstructure Science, Vol. 16, Einspruch and Watts eds., Academic Press, New York, 1987.) A finely focused ion beam may be used to directly write features, such as nanochannels 185, on a layer of resist without use of a mask. Alternatively, broad ion beams may be used in combination with masks to form features as small as 100 nm in scale. Chemical etching, for example with hydrofluoric acid, is used to remove exposed silicon that is not protected by resist. The skilled artisan will realize that the techniques disclosed above are not limiting, and that nanochannels 185 may be formed by any method known in the art.

Such techniques may be readily adapted for use in the disclosed methods and apparatus. In some embodiments of the invention, the microcapillary may be fabricated from the same materials used for fabrication of a loading chamber 180, using techniques known in the art.

In one embodiment of the invention, a compact, microfluidic device, made of a suitably inert material, for example a silicon-based material, is imprinted such that a sample of molecules to be analyzed and Raman-active surfaces may be manufactured into or delivered to the sample cell. A glass window provides a view of the focused laser spot and also seals the solution from surrounding environment, which is important for air sensitive molecules. The cell may have a port for purging the solution with an inert gas. In addition the cell may have ports of a size to allow the sample containing an analyte to be tested and the Raman-active nanoparticles, aggregates, and colloids to flow into the cell, make contact with each other, and flow out of the cell, thus allowing the sample to be constantly replenished during the course of the test, which ensures maximum sensitivity.

d. Flow Paths

In certain embodiments of the invention, nanoparticles 240 may be manipulated into microfluidic channels, nanochannels, or microchannels 185 by any method known in the art, such as microfluidics, nanofluidics, hydrodynamic focusing or electro-osmosis. For example one embodiment of the invention, the analytes 210 to be detected and/or nanoparticles, aggregates, or colloids may be introduced through loading chamber 180 and move down the sample cell 175 and/or microfluidic channel, nanochannel, and/or microchannels 185 by bulk flow of solvent. In other embodiments of the invention, microcapillary electrophoresis may be used to transport analytes 210 down the sample cell 175 and/or microfluidic channel, nanochannel, and/or microchannel 185. Microcapillary electrophoresis generally involves the use of a thin capillary or channel that may or may not be filled with a particular separation medium. Electrophoresis of appropriately charged molecular species, such as negatively charged analytes 210, occurs in response to an imposed electrical field, for example positive on the detection unit side and negative on the opposite side. Although electrophoresis is often used for size separation of a mixture of components that are simultaneously added to the microcapillary, it can also be used to transport similarly sized analytes 210. Because the some analytes 210 are larger than others and would therefore migrate more slowly, the length of the sample cell 175 and/or flow paths 185 and the corresponding transit time past the detection unit 195 may kept to a minimum to prevent differential migration from mixing up the order of analytes 210 when different types of analytes are to be detected or identified. Alternatively, the separation medium filling the microcapillary may be selected so that the migration rates of an analyte 210 down the sample cell 175 and/or flow paths 185 are similar or identical. Methods of microcapillary electrophoresis have been disclosed, for example, by Woolley and Mathies (Proc. Natl. Acad. Sci. USA 91: 11348-352, (1994)).

In some embodiments of the invention, use of charged linker compounds or charged nanoparticles 240 may facilitate manipulation of nanoparticles 240 through the use of electrical gradients. In other embodiments of the invention, sample cells 175 and/or flow paths 185 may contain aqueous solutions with relatively high viscosity, such as glycerol solutions. Such high viscosity solutions may serve to decrease the flow rate and increase the reaction time available, for example, for cross-linking analytes 210 to nanoparticles 240. In other embodiments of the invention, sample cells 175 and/or flow paths 185 may contain nonaqueous solutions, including, but not limited to organic solvents.

The sample of analytes to be analyzed and the metallic particulate or colloidal surfaces can be delivered to the sample cell by various means. For example, the metallic particulate or colloidal surfaces can be delivered to the sample of molecule(s) to be analyzed, the sample of molecule(s) to be analyzed can be delivered to metallic particulate or colloidal surfaces, or the molecule(s) to be analyzed and metallic particulate or colloidal surfaces may be delivered simultaneously. As shown in FIGS. 1 and 2, the sample of molecule(s) to be analyzed and/or metallic particulate or colloidal surfaces can be delivered automatically by a device which pumps or otherwise allows the sample to flow into the sample cell through channels 185. Such a device includes linear microfluidic devices. In another embodiment, the sample of the molecule(s) to be analyzed and/or the metallic particulate or colloidal surfaces can delivered manually by placing a drop or drops of the sample solution directly into the sample cell by means of a tube, pipette, or other such manual delivery device. Other methods of feeding the molecular sample of the analyte and the Raman-active surfaces are also possible. As the molecular sample of the analyte flows through the sample cell 175 the output anti-Stokes beam 190 is altered/changed, which is monitored continuously, during the test.

As is evident from these Figures, the optical instrumentation of a SECARS device provides for the introduction of a Raman-active surface in proximity to the analyte (SERS) to be detected and/or identified by a CARS-type device. As part of a linear microfluidic device, the nanoparticles, aggregates, or colloids and the analyte to be analyzed can be combined in various ways. These include: a) attaching or adsorbing the molecular sample of the analyte to the nanoparticle, aggregate, or colloid which are then flowed into the sample cell; b) flowing the molecular sample of the analyte into a sample cell that has nanoparticle, aggregate, or colloid immobilized inside the cell; or c) flowing the nanoparticle, aggregate, or colloids and the molecular sample of the analyte through a device with bifurcated microfluidic channels which mix inflowing nanoparticle, aggregate, or colloid and inflowing the molecular sample of the analyte, and allow for optical measurerment to be made once the nanoparticles, aggregates, or colloids are completely mixed with the molecular sample of the analyte.

Several different embodiments are envisioned to accomplish this technique on a microscale, including but not limited to the use of various wavelengths, waveguides, optical couplings/choice of pump beams, and the like in order to achieve a precise emission orientation that allows for the detection and identification of a sample of only a small number of molecules of an analyte. As mentioned above, the two separate wavelengths of Raman light must be chosen to correspond to the vibrational energy level of the target analyte and to orient the highly directional output. For example, in order to probe adenine ring breathing mode at 735 cm⁻¹, the excitation light can be tuned to 785 nm and the Stokes light can be tuned to 833 nm so that their energy level difference matches the vibrational energy level of 735 cm⁻¹.

Raman Labels

Certain embodiments of the invention may involve attaching a label to one or more molecules of an analyte 210 to facilitate their measurement by the Raman detection unit 195. Non-limiting examples of labels that could be used for Raman spectroscopy include TRIT (tetramethyl rhodamine isothiol), NBD (7-nitrobenz-2-oxa-1,3-diazole), Texas Red dye, phthalic acid, terephthalic acid, isophthalic acid, cresyl fast violet, cresyl blue violet, brilliant cresyl blue, para-aminobenzoic acid, erythrosine, biotin, digoxigenin, 5-carboxy-4′,5′-dichloro-2′,7′-dimethoxy fluorescein, 5-carboxy-2′,4′,5′,7′-tetrachlorofluorescein, 5-carboxyfluorescein, 5-carboxy rhodamine, 6-carboxyrhodamine, 6-carboxytetramethyl amino phthalocyanines, azomethines, cyanines, xanthines, succinylfluoresceins, aminoacridine, quantum dots, carbon nanotubes, fullerenes, organocyanides, such as isocyanide, and the like. These and other Raman labels may be obtained from commercial sources (e.g., Molecular Probes, Eugene, Oreg.; Sigma Aldrich Chemical Co., St. Louis, Mo.) and/or synthesized by methods known in the art (See Chem. Commun., 724 (2003)).

Polycyclic aromatic compounds may function as Raman labels, as is known in the art. Other labels that may be of use for particular embodiments of the invention include cyanide, thiol, chlorine, bromine, methyl, phosphorus and sulfur. In certain embodiments of the invention, carbon nanotubes may be of use as Raman labels. The use of labels in Raman spectroscopy is known (e.g., U.S. Pat. Nos. 5,306,403 and 6,174,677). The skilled artisan will realize that the Raman labels used should generate distinguishable Raman spectra and may be specifically bound to or associated with different types of analytes 210.

Labels may be attached directly to the molecule(s) of the analyte 210 or may be attached via various linker compounds. Cross-linking reagents and linker compounds of use in the disclosed methods are further described below. Alternatively, molecules that are covalently attached to Raman labels are available from standard commercial sources (e.g., Roche Molecular Biochemicals, Indianapolis, Ind.; Promega Corp., Madison, Wis.; Ambion, Inc., Austin, Tex.; Amersham Pharmacia Biotech, Piscataway, N.J.). Raman labels that contain reactive groups designed to covalently react with other molecules, such as nucleotides, are commercially available (e.g., Molecular Probes, Eugene, Oreg.). Methods for preparing labeled analytes are known (e.g., U.S. Pat. Nos. 4,962,037; 5,405,747; 6,136,543; 6,210,896).

There are two main theories behind the enhancements of this invention but neither is well understood nor important to the description of the invention.

As will be appreciated from the foregoing description, the response time of the sensor of this invention and the method of this invention is limited only by the characteristics of the differential detecting device and its associated sampling and computing circuits. Commercially available integrated preamplifiers provide a response time in the range of a few picoseconds. These ultrafast response times enables initial transients and other shifts which may occur during the test or analysis to be monitored and allowed for and also permits rapid calibratory checks to be made. The invention enables the desired reflectivity characteristic to be determined on a time scale so short that it is less than the time taken for chemical bonding to be achieved between the relevant constituent of the sample and the metallic or semiconductive particulate or colloidal surface.

The high resolution, fast response times, and compact design of the invention allows for the methods and devices of this invention to be used in numerous biological, biochemical, and chemical applications where it is useful to detect and identify small numbers of molecules of a particular analyte. One particular application of these devices and methods is to sequence a polymer such as a single strand of a nucleic acid such as DNA or RNA by detecting and identifying small numbers of labeled or unlabeled nucleotide molecules which have been sequentially cleaved from a strand of the nucleic acid. For example, both the nucleotide and metal particles may be introduced via an aqueous/buffer solution in a microchannel to a miniaturized sample cell for detection.

The following examples are provided to further illustrate specific aspects and practices of this invention. These examples describe particular embodiments of the invention, but are not to be construed as limitations on the scope of the invention or the appended claims.

### EXAMPLE 1

### SECARS Setup 1

This setup comprises two lasers. One laser, the pump laser, emits the pump beam, and the other laser, the Stokes laser, emits the Stokes beam. The pump laser generates 10 nJ pulses with 1 picosecond pulse width at 76 MHz repetition. The Stokes laser generates 6 nJ pulses with 1 picosecond pulse width at 76 MHz Repetition. The pump and Stokes lasers operate in synchronization by connection with an electronic controller (SynchroLock AP from Coherent) which synchronizes the timing of output pulses generated by the two lasers. Two titanium sapphire lasers from Coherent (Santa Clara, Calif.) provide the pump and Stokes beams. The two beams are spatially overlapped by dichroic mirrors and manufactured by Chroma (Brattleboro, Vt.). The beams are tuned to specific wavelengths so that the energy level difference of the two beams matches a certain vibration energy level of the target analyte. The beams are delivered onto the detection window region of the microfluidic channel via a microscope objective lens (Zeiss).

Preparation of Reaction Chamber, Microfluidic Channel and Microchannel

Borofloat glass wafers (Precision Glass & Optics, Santa Ana, Calif.) are pre-etched for a short period in concentrated HF (hydrofluoric acid) and cleaned before deposition of an amorphous silicon sacrificial layer in a plasma-enhanced chemical vapor deposition (PECVD) system (PEII-A, Technics West, San Jose, Calif.). Wafers are primed with hexamethyldisilazane (HMDS), spin-coated with photoresist (Shipley 1818, Marlborough, Mass.) and soft-baked. A contact mask aligner (Quintel Corp. San Jose, Calif.) is used to expose the photoresist layer with one or more mask designs, and the exposed photoresist removed using a mixture of Microposit developer concentrate (Shipley) and water. Developed wafers are hard-baked and the exposed amorphous silicon removed using CF₄ (carbon tetrafluoride) plasma in a PECVD reactor. Wafers are chemically etched with concentrated HF to produce the reaction chamber and microfluidic channel or microchannel. The remaining photoresist is stripped and the amorphous silicon removed.

Nanochannels are formed by a variation of this protocol. Standard photolithography as described above is used to form the micron scale features of the integrated chip. A thin layer of resist is coated onto the chip. An atomic force microscopy/scanning tunneling probe tip is used to remove a 5 to 10 nm wide strip of resist from the chip surface. The chip is briefly etched with dilute HF to produce a nanometer scale groove on the chip surface. In the present non-limiting example, a channel with a diameter of between 500 nm and 1 μm is prepared.

Access holes are drilled into the etched wafers with a diamond drill bit (Crystalite, Westerville, Ohio). A finished chip is prepared by thermally bonding two complementary etched and drilled plates to each other in a programmable vacuum furnace (Centurion VPM, J. M. Ney, Yucaipa, Calif.). A nylon filter with a molecular weight cutoff of 2,500 daltons is inserted between the reaction chamber and the microfluidic channel to prevent exonuclease from leaving the reaction chamber.

Nanoparticle Preparation

Silver nanoparticles are prepared according to Lee and Meisel (J. Phys. Chem. 86: 3391-3395, 1982). Gold nanoparticles are purchased from Polysciences, Inc. (Warrington, PA) or Nanoprobes, Inc. (Yaphank, N.Y.). Gold nanoparticles are available from Polysciences, Inc. in 5, 10, 15, 20, 40 and 60 nm sizes and from Nanoprobes, Inc. in 1.4 nm size. In the present non-limiting Example, 60 nm gold nanoparticles are used.

Gold nanoparticles are reacted with alkane dithiols, with chain lengths ranging from 5 nm to 50 nm. The linker compounds contain thiol groups at both ends of the alkane to react with gold nanoparticles. An excess of nanoparticles to linker compounds is used and the linker compounds are slowly added to the nanoparticles to avoid formation of large nanoparticle aggregates. After incubation for two hours at room temperature, nanoparticle aggregates are separated from single nanoparticles by ultracentrifugation in 1 M sucrose. Electron microscopy reveals that aggregates prepared by this method contain from two to six nanoparticles per aggregate. The aggregated nanoparticles are loaded into the microchannel by microfluidic flow. A constriction at the far end of the microchannel holds the nanoparticle aggregates in place.

Porous Substrate Preparation

The substrate was prepared by anodic, electrochemical etching, as described above. More specifically, the substrate was prepared by subjecting a highly boron-doped, p-type silicon wafer to etching in an aqueous electrolyte solution containing ethanol and HF present in a concentration of about 15 percent by volume based on the total volume of the solution (15% HF by volume). Anodization was carried out by a computer-controlled constant current applied across the cell (between a platinum cathode and the silicon anode). Multiple layers of porous silicon were produced from 5 periods of two different current density settings. One such setting was 5 mA/cm² for 20 seconds, which provided a layer having a porosity of about 42% and a thickness of about 80 nm. The other setting was 30 mA/cm for 10 seconds, which provided a layer having a porosity of about 63% porosity, and a thickness of about 160 nm. The formed substrate was of a circular, disc shape with a diameter of about one inch. Though the formed substrate can generally be considered to be homogenous, there were slight variations (e.g., porosity, thickness, etc.) when comparing the center portion of the substrate to the edge portions of the substrate. Such layers may be attributable to the nature of layer-forming process. The slight variations are evident when comparing the optical emission spectra light (of about 1 micrometer in cross-sectional diameter) excited toward the center portion or the substrate versus light excited toward the edge portions of the substrate.

Nucleic Acid Preparation and Exonuclease Treatment

Human chromosomal DNA is purified according to Sambrook et al. (1989). Following digestion with Bam HI, the genomic DNA fragments are inserted into the multiple cloning site of the pBluescript® 11 phagemid vector (Stratagene, Inc., La Jolla, Calif.) and grown up in E. coli. After plating on ampicillin-containing agarose plates a single colony is selected and grown up for sequencing. Single-stranded DNA copies of the genomic DNA insert are rescued by co-infection with helper phage. After digestion in a solution of proteinase K:sodium dodecyl sulphate (SDS), the DNA is phenol extracted and then precipitated by addition of sodium acetate (pH 6.5, about 0.3 M) and 0.8 volumes of 2-propanol. The DNA containing pellet is resuspended in Tris-EDTA buffer and stored at −20° C. until use. Agarose gel electrophoresis shows a single band of purified DNA.

M13 forward primers complementary to the known pBluescript® sequence, located next to the genomic DNA insert, are purchased from Midland Certified Reagent Company (Midland, Tex.). The primers are covalently modified to contain a biotin moiety attached to the 5′ end of the oligonucleotide. The biotin group is covalently linked to the 5′-phosphate of the primer via a (CH₂)₆ spacer. Biotin-labeled primers are allowed to hybridize to the ssDNA template molecules prepared from the pBluescript® vector. The primer-template complexes are then attached to streptavidine coated beads according to Dorre et al. (Bioimaging 5: 139-152, (1997)). At appropriate DNA dilutions, a single primer-template complex is attached to a single bead. A bead containing a single primer-template complex is inserted into the reaction chamber of a sequencing apparatus.

The primer-template is incubated with modified T7 DNA polymerase (United States Biochemical Corp., Cleveland, Ohio). The reaction mixture contains unlabeled deoxyadenosine-5′-triphosphate (dATP) and deoxyguanosine-5′-triphosphate (dGTP), digoxigenin-labeled deoxyuridine-5′-triphosphate (digoxigenin-dUTP) and rhodamine-labeled deoxycytidine-5′-triphosphate (rhodamine-dCTP). The polymerization reaction is allowed to proceed for 2 hours at 37° C. After synthesis of the digoxigenin and rhodamine labeled nucleic acid, the template strand is separated from the labeled nucleic acid, and the template strand, DNA polymerase and unincorporated nucleotides are washed out of the reaction chamber. In alternative embodiments of the invention, all deoxynucleoside triphosphates used for polymerization are unlabeled. In other alternative embodiments, single stranded nucleic acids may be directly sequenced without polymerization of a complementary strand.

Exonuclease activity is initiated by addition of exonuclease III to the reaction chamber. The reaction mixture is maintained at pH 8.0 and 37° C. As nucleotides are released from the 3′ end of the nucleic acid, they are transported by microfluidic flow down the microfluidic channel. At the entrance to the microchannel, an electrical potential gradient created by the electrodes drives the nucleotides out of the microfluidic channel and into the microchannel. As the nucleotides pass through the packed nanoparticles, they are exposed to excitatory radiation from a laser. Raman emission spectra are detected by the Raman detector as disclosed below.

Raman Detection of Nucleotides

The Raman scattered light from the sample of molecules is collected by the same microscope objective, and passes the dichroic mirror to the Raman detector. The Raman detector comprises a focusing lens, a spectrograph, and an array detector. The focusing lens focuses the Raman scattered light through the entrance slit of the spectrograph. The spectrograph (RoperScientific) comprises a grating that disperses the light by its wavelength. The dispersed light is imaged onto an array detector (back-illuminated deep-depletion CCD camera by RoperScientific). The array detector is connected to a controller circuit, which is connected to a computer for data transfer and control of the detector function.

The Raman detector is capable of detecting and identifying single, unlabeled molecules moving past the detector. The lasers and detector are arranged so that the sample of molecules is excited and detected as it passes through a region of closely packed nanoparticles in the nanochannel or microchannel. The nanoparticles are cross-linked to form “hot spots” for Raman detection. By passing the nucleotides through the nanoparticle hot spots, the sensitivity of Raman detection is increased by many orders of magnitude.

The sample of the molecule(s) to be analyzed and the metallic nanoparticles are delivered manually by placing a drop or drops of the sample solution directly into the sample cell by means of a tube, pipette, or other such manual delivery device.

The sample of molecule(s) and the colloidal silver particles are separately introduced to the microfluidic chip, and mixed before the stream reaches the detection window. The mix of the sample of molecule(s) and the silver colloids, when excited by the two laser beams, generates the SECARS signal. The Raman emission signal that results from the return of the electrons to a lower energy state is collected by the same microscope objective used for excitation, and another dichroic mirror in the beam path steers the signal toward the Raman spectroscopic detector, an avalanche photodiode detector (EG&G). A signal amplifier and an analog-digital converter are used to convert the signal to digital output. A computer is be used to record the digital output and mathematically process the data.

### EXAMPLE 2

### SECARS Setup 2

In an alternate SECARS setup, a titanium sapphire laser from Spectra-Physics (Mountain View, Calif.) generates pulsed laser beam. The laser pulses are used by an optical parametric oscillator (OPO) available from Spectra-Physics, which generates two synchronized beams at two different wavelengths. By turning the optical crystal within the OPO, the wavelength difference between the two beams can vary. The two beams generated by OPO are delivered to the detection window region of the microfluidic channel using micro-optics. The angle of the two beams are set to match the phase matching condition (Fayer, Ultrafast Infrared and Raman spectroscopy, Marcel-Dekker, 2001) under which condition the SECARS signals are generated most efficiently. The colloidal silver particles are already attached to the bottom surface (e.g. calcium fluoride or magnesium fluoride window) of the microfluidic channel. When the sample of molecule(s) is introduced into the microfluidic channel, the molecule(s) temporarily adsorbs onto or moves closer to the colloidal silver particles attached to the surface. When a molecule is excited by the two beams, the SECARS signal is generated as a coherent unidirectional beam. The direction of the SECARS signal is again determined by the phase matching condition. A photomultiplier tube (EG&G) is located at the direction of the SECARS signal, and collects the signal. An amplifier, an A/D converter, and a computer can be used for data capturing, display, and process.

### EXAMPLE 3

### SECARS Setup 3

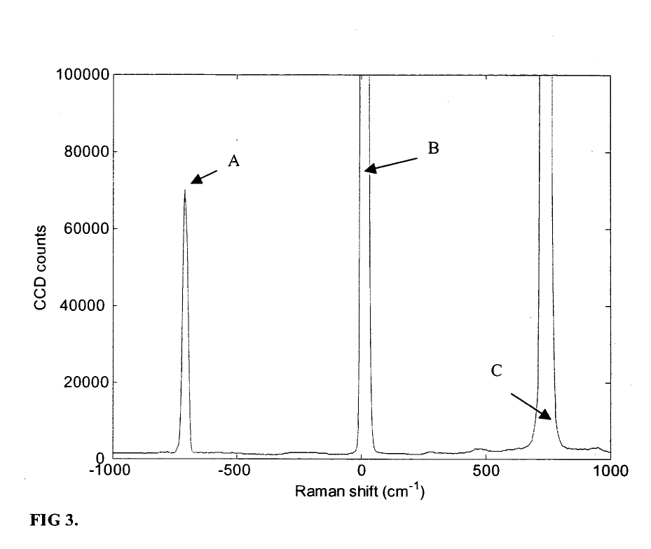

In an alternate SECARS setup, the excitation beams are generated by two titanium:sapphire lasers (Mira by Coherent). The laser pulses from both lasers are overlapped by a dichromatic interference filter (made by Chroma or Omega Optical) into a collinear geometry with the collected beam. The overlapped beam passes through a microscope objective (Nikon LU series), and is focused onto the Raman active substrate where target analytes are located. The Raman active substrate is metallic nanoparticles. The analytes are mixed with lithium chloride salt. The Raman scattered light from the analytes is collected by the same microscope objective, and is reflected by the second dichroic mirror to the Raman detector. The Raman detector comprises a bandpass filter, a focusing lens, a spectrograph, and an array detector. The bandpass filter attenuates the laser beams and transmits the signal from the analyte. The focusing lens focuses the Raman scattered light through the entrance slit of the spectrograph. The spectrograph (Acton Research) comprises a grating that disperses the light by its wavelength. The dispersed light is imaged onto an array detector (back-illuminated deep-depletion CCD camera by RoperScientific). The array detector is connected to a controller circuit, which is connected to a computer for data transfer and control of the detector function. The results are shown in FIG. 3.

### COMPARATIVE EXAMPLE 4

### SERS Setup 1

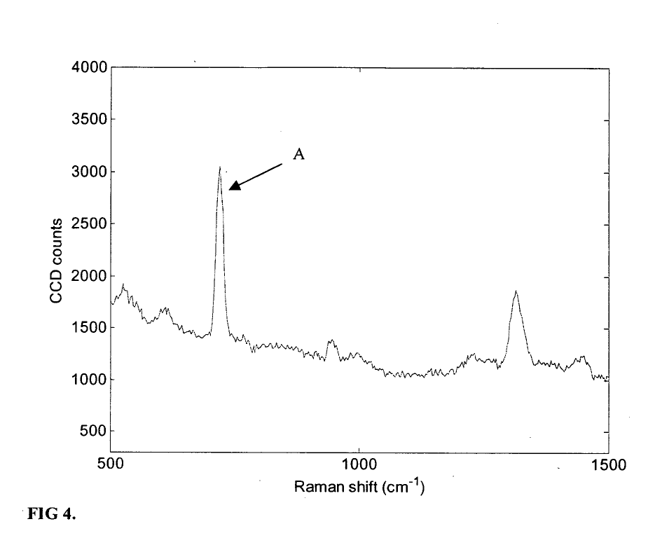

FIG. 4 was generated by using a single titanium:sapphire laser. The laser generates 0.5-1.0 W laser beam at near-infrared wavelength (700 nm ˜1000 nm) in continuous-wave mode or in pulsed mode. The laser beam passes through a dichromatic mirror and a microscope objective, and is focused onto the Raman active substrate where target analytes are located. The Raman active substrate is metallic nanoparticles or metal-coated nanostructures. The analytes are mixed with lithium chloride salt. The Raman scattered light from the analytes is collected by the same microscope objective, and is reflected by the dichroic mirror to the Raman detector. The Raman detector comprises a notch filter, a focusing lens, a spectrograph, and an array detector. The notch filter (Kaiser Optical) attenuates the laser beam and transmits the signal from the analyte. The focusing lens focuses the Raman scattered light through the entrance slit of the spectrograph. The spectrograph (Acton Research) comprises a grating that disperses the light by its wavelength. The dispersed light is imaged onto an array detector (back-illuminated deep-depletion CCD camera by RoperScientific). The array detector is connected to a controller circuit, which is connected to a computer for data transfer and control of the detector function.

### COMPARATIVE EXAMPLE 5

### CARS Setup 1

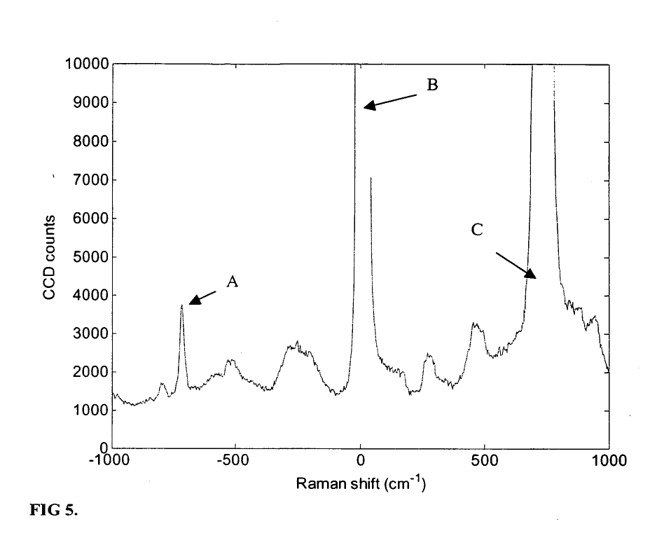

In a CARS setup, the excitation beams are generated by two titanium:sapphire lasers (Mira by Coherent). The laser pulses from both lasers are overlapped by a dichromatic interference filter (made by Chroma or Omega Optical) into a collinear geometry with the collected beam. The overlapped beam passes through a microscope objective (Nikon LU series), and is focused onto the Raman active substrate where target analytes are located. No Raman active substrate is used. The analytes are directly introduced into the sample cell. The Raman scattered light from the analytes is collected by the same microscope objective, and is reflected by the second dichroic mirror to the Raman detector. The Raman detector comprises a bandpass filter, a focusing lens, a spectrograph, and an array detector. The bandpass filter attenuates the laser beams and transmits the signal from the analyte. The focusing lens focuses the Raman scattered light through the entrance slit of the spectrograph. The spectrograph (Acton Research) comprises a grating that disperses the light by its wavelength. The dispersed light is imaged onto an array detector (back-illuminated deep-depletion CCD camera by RoperScientific). The array detector is connected to a controller circuit, which is connected to a computer for data transfer and control of the detector function. The results shown in FIG. 5.

A comparison of FIG. 3 with FIGS. 4 and 5 show that the SECARS technique shows a 25 fold increase in sensitivity when compared with SERS alone and is 30,000,000 fold increase in sensitivity when compared to the use of CARS alone. This 30,000,000 fold increase in sensitivity makes the detection of small numbers of molecules (less than 1000, 100, or 10 molecules or even a single molecule) feasible.

The above examples demonstrate the novelty and utility of the high-resolution SECARS device and method of the invention. The foregoing detailed description of the preferred embodiments of the invention has been given for clearness of understanding only, and no unnecessary limitations should be understood therefrom, as modifications will be obvious to those skilled in the art. Variations of the invention as hereinbefore set forth can be made without departing from the scope thereof, and, therefore, only such limitations should be imposed as are indicated by the appended claims.

### EXAMPLE 6

Two titanium-doped sapphire (ti:sapphire) lasers were used as light sources. The lasers (brand name Mira) are available from Coherent (Santa Clara, Calif.). Each ti:sapphire laser was pumped by a diode-pumped solid-state laser generating 6W of 532 nm light (brand name Verdi). The pump laser was tuned to generate 785 nm light. The Stokes laser was tuned to match the vibrational level of the target molecules. For example, when dGMP molecule was probed, the Stokes laser was tuned to 827.7 nm and the SECARS signal was detected around 746.5 nm (which equals 657 cm⁻¹). When angiotensin I peptide (obtained from New England Biolabs, Beverly, Mass.) was probed, the Stokes laser was tuned to 852.4 nm. The SECARS signal was emitted around 727.7 nm (which equals 1007 cm⁻¹).

The target molecules of interest were probed in a mixture with silver colloidal nanoparticles and lithium chloride salt. The silver colloids were synthesized in-house, as described above. Signal was collected from a control sample containing a mixture of silver colloidal nanoparticles and lithium chloride salts. The signal of control was subtracted from the signal obtained from samples.

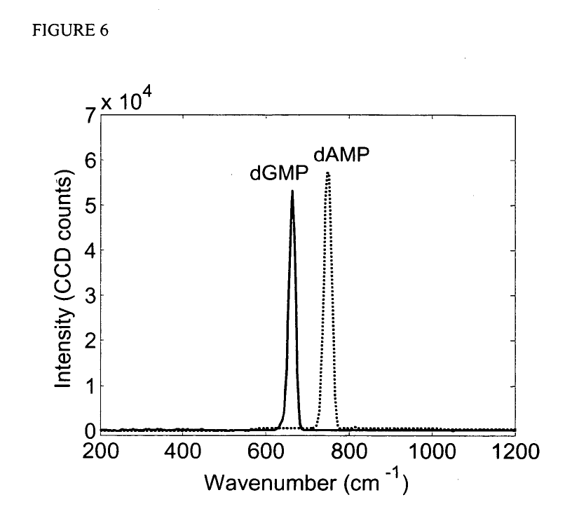

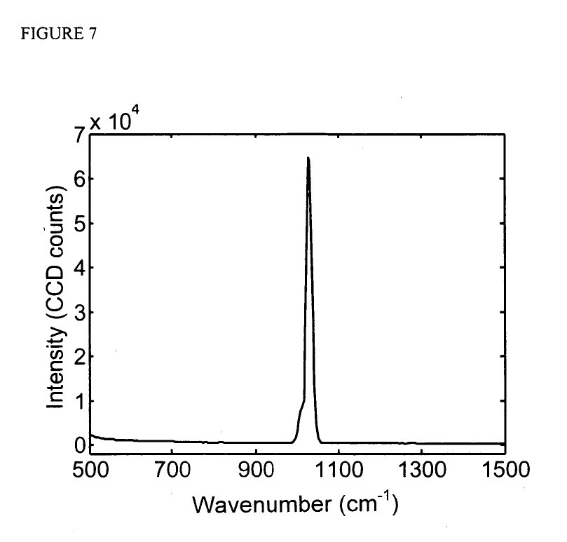

FIG. 6 shows the signal collected from dAMP and dGMP at 90 pM. Based on the collection volume of less than 100 fL, we estimated that less than five molecules were present on average within the collection volume at this concentration. FIG. 7 shows the strong signal of angiotensin I peptide at 90 ng/uL concentration. These results indicate that SECARS can be applied to broad range of molecules, including nucleotides and peptides.

1. A method of detecting or identifying an analyte comprising:
a) exposing less than about 10⁵ molecules of an analyte to at least one Raman-active surface;
b) irradiating the interface between at least one molecule and said surface with a laser beam at a first wavelength, such that said molecule produces a spontaneous Stokes Raman emission at a second wavelength and a spontaneous anti-Stokes Raman emission at a third wavelength;
c) substantially simultaneously with b), irradiating the interface between said molecule and the surface with a second beam at said second wavelength, such that the intensity of said anti-Stokes Raman emission from said molecule at said third wavelength increases; and
d) detecting or identifying said analyte by detecting or identifying the intensity change of said anti-Stokes emission from the interface at said third wavelength following b) and c).

2. The method of claim 1, comprising exposing less than about 10⁴ molecules of an analyte to at least one Raman-active surface.

3. The method of claim 1, comprising exposing less than about 10² molecules of an analyte to at least one Raman-active surface.

4. The method of claim 1, comprising exposing less than about 10 molecules of an analyte to at least one Raman-active surface.

5. The method of claim 1 further comprising moving said analyte through a channel.

6. The method of claim 5 further comprising detecting and identifying said analyte in aqueous media.

7. The method of claim 1 wherein said surface is provided by a member selected from the group consisting of a silicon substrate coated with a metal or conductive material; a metallic or conductive nanoparticle; an aggregate of metallic or conductive nanoparticles; a colloid of metallic or conductive nanoparticles; and combinations thereof.

8. The method of claim 1, wherein the analyte is selected from the group consisting of an amino acid, peptide, polypeptide, protein, glycoprotein, lipoprotein, nucleoside, nucleotide, oligonucleotide, nucleic acid, sugar, carbohydrate, oligosaccharide, polysaccharide, fatty acid, lipid, hormone, metabolite, cytokine, chemokine, receptor, neurotransmitter, antigen, allergen, antibody, substrate, metabolite, cofactor, inhibitor, drug, pharmaceutical, nutrient, prion, toxin, poison, explosive, pesticide, chemical warfare agent, biohazardous agent, bacteria, virus, radioisotope, vitamin, heterocyclic aromatic compound, carcinogen, mutagen, narcotic, amphetamine, barbiturate, hallucinogen, waste product and contaminant.

9. The method of claim 8, wherein the analyte is a nucleoside, nucleotide, oligonucleotide, nucleic acid, amino acid, peptide, polypeptide or protein.

10. The method of claim 9, wherein said analyte is a nucleic acid.

11. The method of claim 1, wherein said analyte is closely associated with a Raman-active surface.

12. The method of claim 1, wherein the Raman-active surfaces are covalently modified with organic compounds.

13. The method of claim 5, wherein said channel is selected from the group consisting of a microfluidic channel, a nanochannel, a microchannel, and combinations thereof.

14. The method of claim 13, wherein said nanoparticles are between about 1 nm and 2 μm in size.

15. The method of claim 13, wherein the size of said nanoparticles is selected from the group consisting of about 10 to 50 nm, about 50 to 100 nm, about 10 to 100 nm, about 100 nm and about 200 nm.

16. The method of claim 7, wherein the metal is selected from the group consisting of gold, silver, copper, platinum, aluminum, and combinations thereof.

17. The method of with claim 1, wherein said Raman detection device is selected from the group consisting of photodiodes, avalanche-photodiodes, charge coupled device arrays, CMOS arrays, intensified charge coupled devices, and combinations thereof.

18. The method as claimed in claim 1 further comprising comparing the detected intensity for the analyte to a previously identified analyte so that the identity of the analyte can be determined.

19. The method of claim 1 wherein the method has an optical cross section of at least about 10⁻²² cm² per molecule.

20. The method of claim 1 wherein the method has an optical cross section of at least about 10⁻²⁰ cm² per molecule.

21. The method of claim 1 wherein the method has an optical cross section of at least about 10⁻¹⁹ cm² per molecule.

22. The method of claim 1 wherein the method has an optical cross section of at least about 10⁻¹⁸ cm² per molecule.

23. The method of claim 1 wherein the method has an optical cross section of at least about 10⁻¹⁷ cm² per molecule.

24. The method of claim 1 wherein the method has an optical cross section of at least about 10⁻¹⁶ cm² per molecule.

25. The method of claim 1 wherein the method has an optical cross section of at least about 10⁻¹⁵ cm² per molecule.

26. The method of claim 1 wherein the method has an optical cross section of at least about 10⁻¹⁴ cm² per molecule.

27. The method of claim 1 wherein the method has an optical cross section of at least about 10⁻¹³ cm² per molecule.

28. The method of claim 1 wherein the method has an optical cross section of at least about 10⁻¹² cm² per molecule.

29. The method of claim 1, wherein said analyte is labeled with one or more distinguishable Raman labels.

30. The method of claim 1, further comprising imposing an electric field to move said analyte through said channel.

31. The method of claim 1, wherein each type of analyte produces a unique Raman signal.

32. A device for detecting less than about 10³ molecules of an analyte, said device comprising:
(a) means for producing a first beam of electromagnetic radiation at a first wavelength;
(b) means for producing a second beam of electromagnetic radiation at a second wavelength, said second wavelength differing from said first wavelength;
(c) a sample cell;
(d) means for introducing said analyte and a Raman-active surface to said sample cell;
(e) optics for focusing said first beam and said second beam onto an interface between said analyte and said Raman active surface; and
(f) means for detecting the intensity of light emitted from the interface between the analyte and the Raman-active surface, positioned to receive said emission.

33. A device in accordance with claim 32, wherein said means for producing a first beam of electromagnetic radiation and said means for producing a second beam of electromagnetic radiation comprise two pulsed lasers.

34. A device in accordance with claim 32, wherein said optics comprises a microscope objective lens, a mirror, a prism, or combinations thereof.

35. A device in accordance with claim 32, wherein said sample cell comprises:
(a) a sample cell body of a material that isolates said sample from ambient air;
(b) a window in said sample cell body of a material that is transparent to electromagnetic radiation; and,
(c) at least one port for introducing and removing said analyte and optionally the Raman-active surface.

36. A device in accordance with claim 32, wherein said means for introducing an analyte and a Raman-active surface to said sample cell comprises a microfluidic device.

37. A device in accordance with claim 32, wherein said means for detecting the intensity of light emitted from the interface is a differential photo-detecting device selected from the group consisting of photodiodes, avalanche-photodiodes, charge coupled device arrays, CMOS arrays, intensified charge coupled devices, and combinations thereof.

38. A device for detecting less than about 1 molecules of an analyte, said device comprising:
a) a reaction chamber;
b) a first channel in fluid communication with said reaction chamber;
c) a second channel in fluid communication with said first channel;
d) a sample cell in fluid communication with said first and second channels;
e) a multiplicity of nanoparticles, nanoparticle aggregates, nanoparticle colloids, or a metal-coated substrate in said flow-through cell;
f) a laser; and
g) a surface enhanced, coherent anti-Stokes Raman detector operably coupled to said flow-through cell.

39. The device of claim 38, wherein said Raman detector comprises a CCD camera or a photodiode array.

40. The apparatus of claim 38, wherein said CCD camera or photodiode array is operably coupled to a data processing unit.

41. The apparatus of claim 38, wherein said data processing unit comprises a computer.

42. The apparatus of claim 38, further comprising a first electrode and a second electrode, said electrodes to move single analytes from said first channel into said second channel.

43. The apparatus of claim 38, wherein said first channel is a microfluidic channel.

44. The apparatus of claim 38, wherein said second channel is a nanochannel or a microchannel.

45. The apparatus of claim 38, wherein the nanoparticles are metal.

46. The apparatus of claim 45, wherein the metal comprises silver, gold, platinum, copper and/or aluminum.

47. The apparatus of claim 38, further comprising a flow through cell operably coupled to the Raman detector, wherein flow passes through the metal-coated, nanocrystalline porous silicon substrate inside the sample cell.

48. The apparatus of claim 38, wherein the metal-coated substrate is incorporated into an integrated chip or micro-electro-mechanical system (MEMS).

49. The apparatus of claim 38, wherein said detection unit comprises a laser and a CCD camera.
